(19) United States
(12) Patent Application Publication
(10) Pub. No.: US 2025/0086381 A1
(43) Pub. Date: Mar. 13, 2025

(54) METHOD AND SYSTEM FOR ASSISTANCE IN THE INTERPRETATION OF A DOCUMENT INCLUDING REFERENCES

(71) Applicants: Christophe LEVEILLE, Guyancourt (FR); Rodolphe GUYON, Guyancourt (FR)

(72) Inventors: Christophe LEVEILLE, Guyancourt (FR); Rodolphe GUYON, Guyancourt (FR)

(21) Appl. No.: 18/292,750

(22) PCT Filed: Jul. 26, 2022
(86) PCT No.: PCT/FR2022/051501

§ 371 Date: Jan. 26, 2024

(30) Foreign Application Priority Data
Jul. 28, 2021 (FR) FR2108200

(51) Int. Cl. G06F 40/169; G06T 11/60; G06V 30/422

(52) U.S. Cl. CPC G06F 40/169; G06T 11/60; G06V 30/422

(57) ABSTRACT

A method and system for assisting in interpretation of a document, including searching for a reference, searching for a denomination in relationship with the reference, associating a denomination with the reference identified at the end of the first searching, generating a support which illustrates the association, and a modification sequence which makes it possible to correct an absence or error in identifying a reference or a denomination.

A method, system and/or program capable of assisting a user in interpreting a referenced drawing is provided. It falls within the field of information processing systems and pursues the objective of accelerating the understanding of a technical drawing by a user.

Technical literature often includes drawings, figures or diagrams which are commented on or described by text which relates to the drawings. This is, for example, the case for technical instructions for the installation or repair of technical objects. This is also the case for certain industrial property titles, such as patent applications, patents, certificates or utility models.

Reading the text alone does not allow the technical meaning of a disclosure to be correctly interpreted. Likewise, the sole observation of the referenced drawing does not allow us to take the full measure of the object and its components represented in this drawing.

Document US2005/0216828 proposes a system capable of automatically comparing a denomination present in a text with a reference placed on a drawing relating to this text. A support is thus displayed, such a support being made up of the original drawing, with the original references which point to parts of the drawing and next to which a denomination is added which comes from the text and which is related to said reference.

Such a system nevertheless has one or more drawbacks. In fact, the system relies on a character recognition device. However, the effectiveness of this character recognition device depends directly on the quality of the drawing or text. If the latter is of poor quality, the character recognition device may miss one or more references, or one or more denominations.

A second technical problem lies in the fact that the character recognition device generates errors, by identifying a reference while the drawing mentions another reference.

The invention resolves these problems by proposing a method of aiding the interpretation of a document comprising at least one referenced drawing and a text associated with the referenced drawing, during which:
at a first search step, an electronic unit searches in the referenced drawing or in the text for at least one reference,
in a second search step, the electronic unit searches in the text for at least one denomination related to the reference identified by the implementation of the first search step,
at an association step, the electronic unit associates the denomination identified at the end of the second search step with the reference identified at the end of the first search step,
at a generation step, the electronic unit generates a support which illustrates the association step,
   characterized in that the method comprises a modification sequence which, in the absence of identification of at least one reference during the implementation of the first search step or in the event of an error in the identification of at least a reference during the implementation of the first search step or in the event of absence of identification of at least one denomination during the implementation of the second search step or in the event of an error in the identification of at least one denomination during the implementation of the second search step, includes at least:
a step of manual selection of an area of the support,
a step of presenting at least one denomination or a step of manually entering a denomination, in relation to a reference present or entered in the manually selected area of the support,
a step of combining the denomination presented or manually entered with the reference present or manually entered in the area of the support, the combination being displayed on the support.

According to a characteristic of the method, the step of presenting at least one denomination comprises a presentation of a list of denominations, the method comprising a step of choosing a particular denomination from the list of denominations carried out between the step of presentation of at least one denomination related to the reference present or entered manually in the support area and the combination step.

According to another characteristic of the method, the step of presenting the list of denominations comprises at least one step of calculating the occurrence of these denominations and a step of displaying these occurrences on the support. In other words, the electronic unit offers several denominations related to the reference identified at the end of the first search step or entered manually, classified by number of appearances, as identified at the end of the second step of research. A step of ordering the denominations in relation to their occurrence can also be implemented.

According to yet another characteristic of the method, in the absence of identification of at least one reference during the implementation of the first search step, the step of manually selecting an area of the support comprises a sub-step for selecting an area of the support which has not been identified at the end of the first search step and a sub-step for manually entering a reference in the area of the support which has not been identified at the outcome of the first research step.

According to one aspect of the method, in the event of an error in locating at least one reference during the implementation of the first search step, the step of manually selecting an area of the support comprises a sub-step of replacing the reference identified in the drawing at the end of the first search step by a reference entered manually. In a complementary manner, the step of manually selecting an area of the support may include a sub-step of selecting a reference identified in the drawing at the end of the first search step implemented prior to the sub-step of replacement.

Note that the electronic unit identifies the denomination in relation to the reference entered manually by implementing the second search step, then combines on the support said denomination identified with the reference entered manually.

According to another aspect of the method, in the absence of identification by the electronic unit of the denomination in relation to the reference entered manually, the modification sequence comprises a step of manually entering a denomination and a step of combining this denomination entered manually to the reference entered manually.

According to another option of the method, the electronic unit combines the denomination entered manually by a user with the reference identified at the end of the first search step or entered manually.

Advantageously, the support is at least one annotated drawing comprising the referenced drawing and at least one denomination associated with a reference by implementing the association step and at least one denomination combined with a reference by implementing the modification sequence.

The electronic unit transfers the denomination identified or entered manually onto the support by placing it near the reference identified during the first search step, or entered manually during the modification sequence.

According to one characteristic, the support comprises at least one glossary comprising at least the denomination identified or entered manually and the reference identified during the first search step or entered manually, the electronic unit associating the glossary with the referenced drawing carrying at least a reference present in the glossary, the electronic unit being configured to report the glossary next to the referenced drawing.

According to an example of implementation of the method which is the subject of the invention, the document is an industrial property title and the referenced drawing is a drawing of the industrial property title, the electronic unit applying the second search step and/or the sequence of modification to at least one claim of the industrial property title.

According to one aspect of the disclosure, the method comprises a step of recording by the electronic unit a position in the text of the reference identified or entered manually and/or a paragraph in the text where appears for the first time the reference identified or entered manually.

According to one option, at the generation step, the electronic unit displays on the support the position in the text and/or paragraph of the reference identified or entered manually.

The invention covers a program for executing a method according to any of the characteristics listed herein, where the program is executed by the electronic unit.

The invention finally covers a system for assisting in the interpretation of a document comprising at least one referenced drawing and a text associated with the referenced drawing, comprising at least:
a first search means, for example the electronic unit, of at least one reference in the referenced text or on the referenced drawings,
a second search means, for example the electronic unit, in the text of at least one denomination related to the reference identified by the first search means,
an association means, for example the electronic unit, associating the denomination identified by the second search means with the reference identified by the first search means,
a means of generation, for example the electronic unit, of a support which illustrates the association made by the association means,
   the system comprising a modification module which comprises:
at least one first means, for example the electronic unit, making it possible to manually select an area of the support,
at least one second means, for example the electronic unit, configured to present at least one denomination in relation to a reference present or entered in the area of the support or configured to manually enter a denomination, and
at least one means of combination, for example the electronic unit, of the denomination presented or entered manually with the reference present or entered manually in the area of the support, the system being configured to display said combination on the support.

Other characteristics, details and advantages of the invention will emerge more clearly on reading the description which follows on the one hand, and an exemplary embodiment given for informational and non-limiting purposes with reference to the appended drawings on the other hand, share, on which:

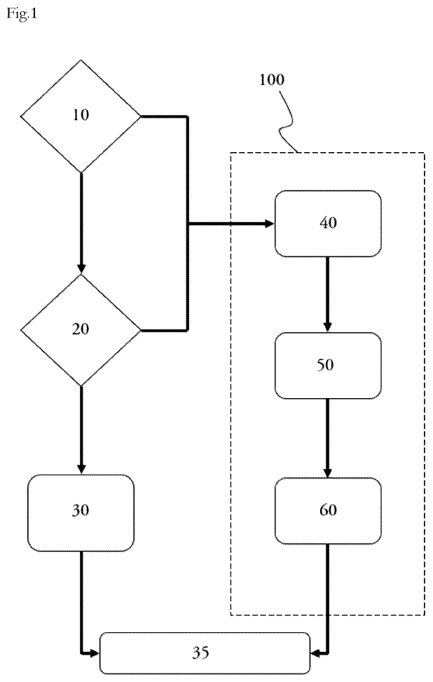

FIG. 1 is a flowchart which illustrates the process according to the invention;

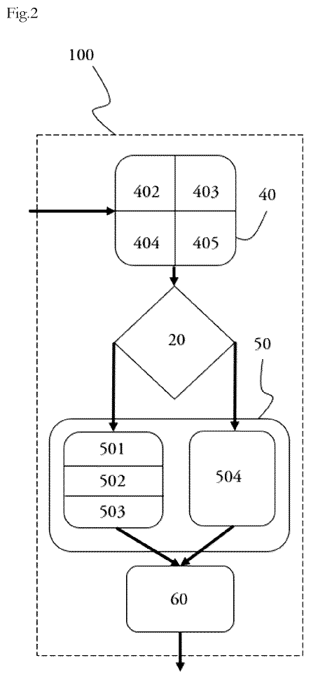

FIG. 2 is a flowchart which details the modification sequence according to the invention;

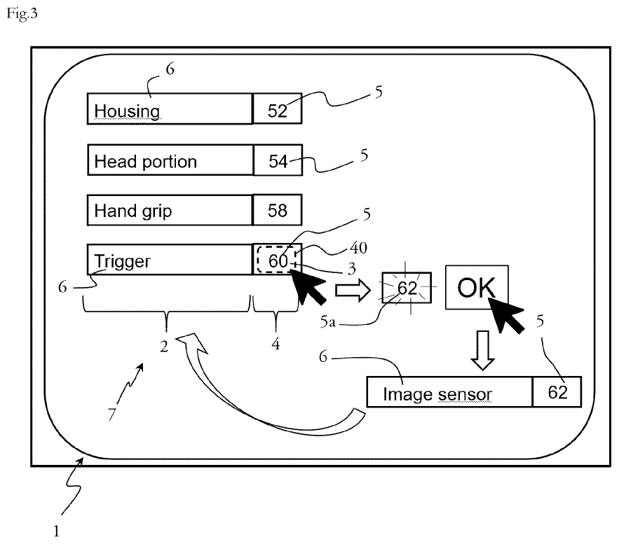

FIG. 3 illustrates a first example of a support generated by the method which is the subject of the invention;

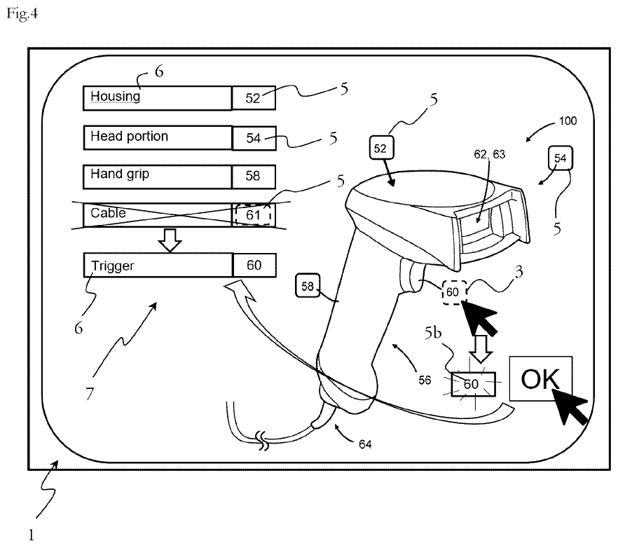

FIG. 4 illustrates a second example of a support generated by the method which is the subject of the invention;

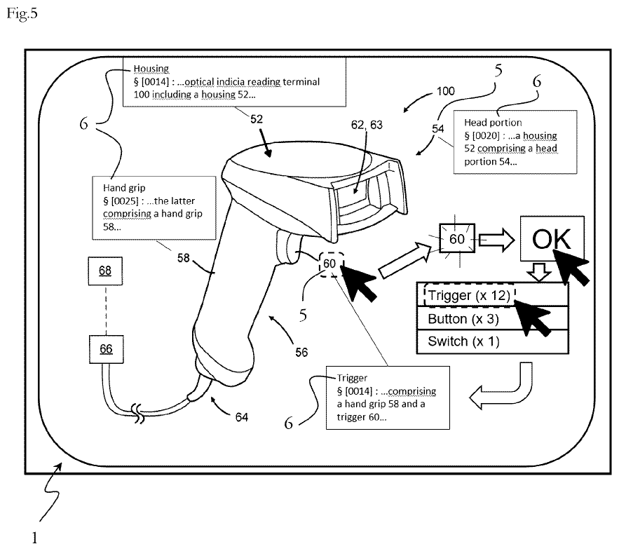

FIG. 5 illustrates a third example of a support generated by the method which is the subject of the invention;

FIG. 6 illustrates a fourth example of a support generated by the method which is the subject of the invention;

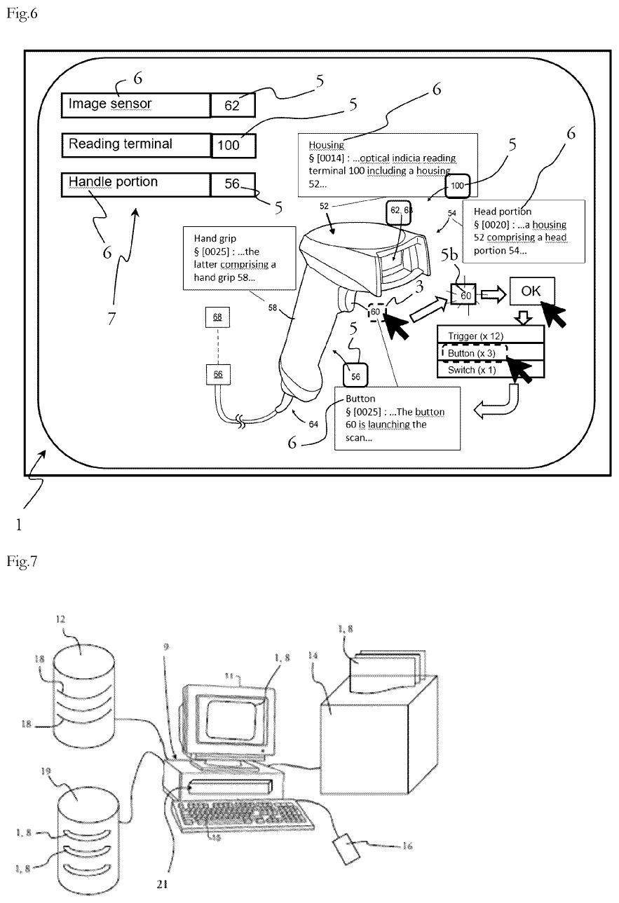

FIG. 7 illustrates an example of means capable of implementing the method according to the invention.

It should first be noted that if the figures present the invention in detail for its implementation, said figures can of course be used to better define the invention, if necessary. It should also be noted that the same elements are designated by the same references in all of the figures. In the description below, the use of the word “reference” in the singular has the same scope and can be understood as “the references”, and vice-versa. The same goes for “naming”.

FIG. 1 represents a flowchart which illustrates the steps of a method according to the invention for interpreting a document which includes alphanumeric references, for example. Such a document consists of at least one so-called “referenced” drawing, in that it contains at least one geometric figure and a drawing reference which illustrates an object or an area of the drawing, and a text associated with this referenced drawing, this text comprising at least one text reference which corresponds to the drawing reference of the referenced drawing and which describes the object or area of the drawing, hereinafter called denomination.

In the description which follows, the referenced drawing corresponds to the original drawing from the document, while the annotated drawing corresponds to a result provided to the user of the process which is the subject of the invention, hereinafter called support.

The method according to the invention comprises at least four steps and a modification sequence, among which we find:
a first search step 10 which consists of locating in the referenced drawing or in the text at least one reference 5,
a second search step 20 which consists of identifying in the text at least one denomination 6 relating to each of the reference 5 previously identified by the implementation of the first search step 10. This second search step 20 is carried out subsequently at the first research step,
an association step 30 which consists of associating the denomination 6 identified during the implementation of the second search step 20 with the reference 5 identified during the implementation of the first search step 10, and
a generation step 35 of a support 1 which consists of generating a display usable by the user and on which is shown the association which results from the association step 30, that is to say the denomination 6 identified at the end of the second search step 20 associated with the reference 5 identified at the end of the first search step 10.

The method which is the subject of the invention pursues the objective of automatically associating a denomination with its reference, combined with the possibility of correcting this association or of completing this association, in the absence of identification, or in the case of an identification judged to be erroneous by the user. The list of references can come from a search in a text or from a search in a drawing.

According to the invention, the first search step 10, the second search step 20, the association step 30 and the generation step 35 of the support are steps carried out on or by an electronic unit, and they are operated automatically, apart from triggering the first search step 10. No manual intervention is involved in the implementation of these steps. The deliverable of these steps is an interactive display on a support computer screen. The deliverable of these steps can also be a document to be printed or printed.

According to the invention, the method comprises a modification sequence 100 which consists of steps which make it possible to correct errors which would result from the implementation of the first search step 10, the second search step 20, the association step 30 and/or generation step 35 of the support 1.

According to the invention, the modification sequence comprises at least a fourth step 40 of manual selection of a zone 3 of the support 1, a fifth step 50 of presentation of at least one denomination or a step of manual entry of a denomination 6, in relation to a reference present or entered in the zone of the support 1 manually selected during the fourth step 40 and a sixth step 60 of combining a denomination presented in the fifth step 50 with the reference present or entered in the zone of the support 1 as it results from the fourth step 40. According to the invention, such a combination or association which is the subject of the sixth step 60 is made apparent on the support 1.

Note that the fifth step 50 mentioned above can also consist of a step of manual entry of a denomination, in particular when the method has not been able to detect a denomination in the text in relation to the reference 5 present or entered in a zone of the support 1.

The steps listed above are implemented by an electronic unit, which can take the form of a single organ, such as a computer, a smartphone or a touchscreen tablet, but which can also take the form of several units connected electrically or electronically to each other. This electronic unit can implement character recognition software to implement the steps cited above.

FIG. 2 shows in detail the modification sequence 100. The fourth step 40 of manually selecting a zone of the support 1 can comprise several sub-steps, such as for example a first sub-step 402 which consists of selecting a reference 5 which has been identified in the referenced drawing at the end of the first search step 10. In other words, the process proposes to intervene on a reference that the process has located and identified, but which is in fact incorrect in relation to what appears in the referenced drawing. This is a case of error in the location of at least one reference 5 during the implementation of the first search step 10, as will be described in more detail in FIG. 3.

In such a case, the fourth step 40 of manually selecting a zone of the support 1 comprises a second sub-step 404 of replacing the reference 5 identified in the drawing at the end of the first search step 10 by a reference entered manually, in particular in an appropriate field and noted 5a in FIG. 3. The erroneously detected reference is thus corrected.

The fourth step 40 of manual selection of an area of the support 1 may comprise a third sub-step 403 which consists of a selection of an area of the referenced drawing which has not been identified at the end of the first search step 10, as illustrated in FIG. 4. This area of the referenced drawing which has not been identified corresponds to any area of the support 1 which does not present any particular sign of computer processing. Such a zone of the support is thus identical in appearance to the referenced drawing before treatment by the process.

According to this third sub-step 403, the method makes it possible to select a zone of interest of the support 1, in particular a zone where there is a reference which was not detected during the first search step 10. The method thus comprises a fourth sub-step 405 of manual entry of a reference 5b in an area of the support 1 which corresponds to the area of the drawing which was not identified at the end of the first search step 10. The user can thus correct the absence of detection of a reference and thus improve the intelligibility of the document via a more complete support 1 than that which results from the first and second search steps 10, 20, and from the association step 30 of the denominations with references.

At the end of the second sub-step 404 of replacing the reference or at the end of the fourth sub-step 405, the method implements a search step similar to second search step 20, where the electronic unit 9 searches in the text for at least one denomination 6 in relation to the manually entered reference 5a, 5b, whether by replacing a previously identified reference or by creating this reference.

At the end of this second search step 20 implemented within the modification sequence 100, the method implements two examples of carrying out the fifth step 50.

A first example of the fifth step 50 of presenting a list of denominations 6 results from the reference 5a, 5b entered manually in the second sub-step 404 or in the fourth sub-step 405, as is illustrated in FIG. 5 or 6. This fifth step 50 includes a step of calculating occurrences 501 of each of the denominations 6 identified during the implementation of the second search step 20. This fifth step 50 also includes an ordering step 502 which aims to arrange the denominations in an increasing order of occurrence, so as to show first the denomination which appears the most times in the text. This fifth step 50 finally includes a display step 503 of this list of denominations 6 thus ordered, thus allowing the user to choose the denomination which appears most appropriate to him in relation to the reference which has been entered manually.

The second example of carrying out the fifth step 50 occurs in the absence of identification by the electronic unit of a denomination relating to the reference entered manually during the second sub-step 404 or the fourth sub-step 405. This is a manual entry step 504 of a denomination 6 in relation to the reference 5a, 5b previously entered manually in sub-steps 404 or 405.

The modification sequence 100 also includes a combination step 60 whose function is similar to the association step 30. The combination step 60 connects the replacement reference 5a of the second sub-step 404 or the reference 5b entered manually from the fourth sub-step 405 with the denomination 6 chosen by the user when examining the display step 503, or with the denomination entered manually during the implementation of the manual entry step 504 of a denomination. According to an alternative covered by the invention, the combination step 60 can be carried out by the technical means which implement the association step 30 of the automatic part of the method, this association step 30 bringing together the entered reference manually with the denomination detected or entered manually.

At the end of the combination step 60 of the modification sequence 100, the method implements the generation step 35 so as to display the support 1 which includes the modifications which result from the modification sequence 100. According to the invention, the support 1 takes the form of a display on a computer, tablet or smartphone screen. The processing and intelligibility of the document are thus improved by using automated detection means associated with manual entries. Once the user has modified the support using modification sequence 100, an image paper document of support 1 can be printed.

FIG. 3 shows an example of the support 1 which is generated in the generation step 35. In the present case, the support 1 takes the form of an electronic document, displayed on a computer, tablet or smartphone screen, and which includes a list 2 of denominations 6 identified at the end of the second search step 20, associated with a list 4 of references 5 identified at the end of the first search step 10. These two lists 2, 4 associated with each other forms a glossary 7 which helps in the interpretation of the document, in particular of its referenced drawing. Several methods for associating the denomination 6 with the reference 5 will be detailed in the description below.

In FIG. 3, a denomination 6 is for example “Head portion” or “Housing”. A denomination 6 can consist of a single word, but the method according to the invention integrates the possibility of identifying several words to form a more complex denomination 6.

A reference 5 is for example “52” or “54”. Such a reference 5 can be formed by any alphanumeric sequence, in particular several numbers, several letters or a combination of number and letter.

Assuming that the reference “60” is incorrect in the sense that, for example, the drawing shows a reference “62”, the modification sequence allows the correct reference to be entered, that is to say “62”, to carry out a denomination search in relation to this manually entered reference and to display a new combination which is “62-Image sensor”. Manual entry of the reference is done by the manual selection fourth step 40 by selecting a zone 3 of the support 1.

In the absence of automatic detection of a denomination, the modification sequence also allows to manually enter the denomination appropriate to the reference “62”.

FIG. 4 illustrates another example of the support 1 which is generated in the generation step 35. In this example, the support 1 takes the form of an electronic document, displayable on a computer, tablet or smartphone screen, and which includes the referenced drawing, that is to say the original drawing which was analyzed to detect references 5, identifiable here by a continuous frame, in the vicinity of which is placed the glossary 7 corresponding to FIG. 3.

The method according to the invention provides a step of selecting references 5 and their associated denominations 6 to retain only those which correspond to the references which are present on the referenced drawing. This selection step guarantees that the glossary 7 placed next to the referenced drawing contains the references relating to the drawing that the process which is the subject of the invention displays, and not references or denominations of another drawing of the document.

The modification sequence allows here, for example, to select a zone 3 of the drawing which has not been identified at the end of the first search step, here framed by a broken line, to enter a reference 5b that the user can read, here the reference “60”. The modification sequence can continue with the automatic detection of the denomination 6 associated with the reference “60”, or the manual entry of this denomination 6, as mentioned above.

FIG. 5 illustrates yet another example of the support 1 which is generated in the generation step 35. In the present case, the support 1 is a drawing annotated 8 which corresponds to a combination of the drawing referenced with at least one denomination 6 positioned immediately next to the reference 5 identified during the implementation of the first search step 10. In this example, the support 1 takes the form of an electronic document, displayable on a computer screen, tablet or smartphone. In the event of a plurality of denominations 6, these are distributed on the annotated drawing 8, each being arranged to the right, to the left, above and/or below a reference 5.

According to one aspect of the disclosure, the automatic part of the method, that is to say the first, second, third and fourth steps 10 to 35, can be combined with a step which consists of selecting an indication of the paragraph, or of the page and the line, where the denomination 6 corresponding to the reference 5 of the drawing identified during the first search step 10 was detected for the first time, or entered manually. A step is then provided for displaying on the support 1 this indication of paragraph, page and line in the vicinity of the denomination 6 in question.

Alternatively or cumulatively, the automatic part of the method, that is to say the first, second, third and fourth steps 10 to 35, can be combined with a step which consists of selecting a context in which appears for the first times the denomination 6 corresponding to the reference 5 of the drawing identified during the first search step 10, or entered manually. A step is then provided for displaying this context on the support 1, by copying several words before and after the denomination in the vicinity of the denomination 6 in question.

The two steps above are also applicable to support 1 after implementing the modification sequence.

Thanks to these two possibilities, the user can more easily understand the meaning of the denomination, and possibly check its presentation in more detail by reading the passage directly in the appropriate text, without having to do a search to find the denomination in question.

Assuming that the detection of the reference “60” located at the level of the handle of the object visible in FIG. 5 is erroneous or is not identified, the modification sequence makes it possible to replace the erroneous or unidentified reference by the reference 5b of this part, here the reference “60”. The modification sequence can continue with the automatic detection in the text of several denominations 6 associated with the reference “60”. These are “Trigger”, “Button” and “Switch”.

The modification sequence may include a step of calculating the occurrence of these denominations 6 within the text, a step of ordering these denominations 6 and a step of displaying these denominations in a decreasing order from top to bottom. The display step shows the occurrences in question, for example in parentheses, which allows the user to make a more informed choice.

Once the user has selected one of these denominations, the modification sequence combines the reference “60” with the denomination 6 chosen by the user and displays it on support 1.

FIG. 6 illustrates another example of support 1 which is generated in the generation step 35. Support 1 is here a combination of the supports generated in the example illustrated in FIG. 4 and in the example illustrated in FIG. 5.

This support 1 takes the form of an annotated drawing 8, that is to say a referenced drawing which includes at least one denomination 6, combined with a glossary 7. Certain denominations 6 are reported directly in the vicinity of the reference 5, while other denominations 6 are associated with a list of references 5 appearing in the glossary 7.

FIG. 6 shows another possibility offered by the method according to the invention. The list of denominations 6 allows the user to select the denomination which appears to him to be the most relevant to designate the reference in question. In the example illustrated here, the user considers that the denomination “Button” is more appropriate than “Trigger” to designate the object referenced “60”, and the method which is the subject of the invention makes it possible to save and display this choice.

The method which is the subject of the invention may comprise an additional sub-step of assigning the same pattern to the reference 5 mentioned in the glossary 7 and to the same reference 5 detected in the drawing. This pattern can be colored and/or follow a particular geometric outline. The use of several different patterns each associated with the same reference makes it possible to accelerate the visual association between the denomination 6 present in the glossary 7 and the part illustrated by the drawing reference.

The method which is the subject of the invention is particularly suitable for the automatic processing of an industrial property title. The document, which forms the input element of the process according to the invention, is in this case a patent application or a patent, whatever its country or organization it belongs to. The document can also be a utility model or utility certificate, for countries or organizations that have one. The invention proposes to select all or part of the text where the steps must be implemented. In the case of an industrial property title, the method comprises a step of selecting the descriptive part of the referenced drawing(s) or at least one claim.

To use the method on a claim, the electronic unit which implements this selection step is configured to select the text corresponding to one or more claims. For example, the electronic unit can identify the word “claim”, or the translation of this word in the language of the industrial property title. Complementarily or alternatively, the claim(s) may be the subject of a dedicated electronic file or a dedicated internet address (URL).

To use the method on a descriptive part of the drawing(s), the electronic unit which implements this selection step is configured to select the text corresponding to this detailed description of the figures or drawings. For example, the electronic unit can locate the word “description” or “detailed description”, or the translation of these words into the language of the industrial property title. Complementarily or alternatively, the descriptive part considered may be the subject of a dedicated electronic file or a dedicated internet address (URL).

As explained above, the support generated in the generation step 35, whether it comes from the automatic part of the process or modified by the modification sequence according to the invention, takes an immaterial form by being displayed on a screen. In such a case, the invention provides for various modes of appearance of the denomination 6 next to the reference 5. For example, the method provides that passing a mouse icon over a reference 5 could cause the denomination to appear on the screen. According to another example, passing the mouse icon over reference 5 will highlight the denomination present in glossary 7, and vice versa.

FIG. 7 illustrates an example of the means capable of implementing the automated part and the modification sequence of the method according to the invention, as described above. The electronic unit 9 implements the method which is the subject of the invention via a program 21. This electronic unit 9 can be local, remote or made up of electronic subassemblies scattered in several distinct locations. This may, for example, be a personal or professional computer, a personal or professional server, a smartphone or a tablet.

The electronic unit 9 which executes the program 21 can be controlled by a keyboard 15 and a mouse 16, or by a touch or voice interface, for example. This electronic unit 9 is connected, by any suitable network, to one or more databases 12 which store and provide access to a document 18 which can be processed by the method and the program 21 according to the invention.

FIG. 7 further shows that the electronic unit 9 is connected to a data storage server 19 which stores in a dematerialized manner the support 1 generated by the method which is the subject of the invention. This arrangement makes it possible to make the support 1 generated by the process available, instantly and without having to implement the process which is the subject of the invention again. Subsequent support releases are therefore faster.

The support 1, for example in the form of a drawing annotated 8, is displayed on a screen 11 connected to the electronic unit 9. This same drawing annotated 8 is also available in paper version and from a printer 14 connected to the electronic unit 9, before or after implementation of the modification sequence.

The invention as it has just been described and illustrated achieves the goals it set for itself, by facilitating the interpretation of a referenced technical drawing. The time required to understand a document can thus be considerably reduced and detection errors or lack of detection can be easily corrected.

The invention as it has just been described cannot, however, be limited to the means and configurations exclusively described and illustrated, and also applies to all equivalent means or configurations and to any combination of such means or configurations.

1-11. (canceled)

12. A method of aiding in interpretation of a document comprising at least one referenced drawing and a text associated with the referenced drawing, the method comprising:
in a first search step, an electronic unit searches in the referenced drawing or in the text for at least one reference;
in a second search step, the electronic unit searches in the text for at least one denomination relating to the reference identified by implementation of the first search step;
at an association step, the electronic unit associates a denomination identified at end of the second search step with the reference identified at end of the first search step;
in a generation step, the electronic unit generates a support which illustrates the association step; and
a modification sequence which, in absence of identification of at least one reference during implementation of the first search step or in event of error in the identification of at least one reference during the implementation of the first search step or in event of absence of identification of at least one denomination during the implementation of the second search step or in the event of error in the identification of at least one denomination during the implementation of the second search step, comprises at least:
a step of manual selection of a zone of the support,
a step of presentation of at least one denomination or a step of manual entry of a denomination, in relation to a reference present or entered in the zone of the support selected manually, and
a step of combining the denomination presented or entered manually with the reference present or entered manually in the zone of the support, the combination being displayed on the support.

13. The method according to claim 12, during which the step of presenting at least one denomination comprises a presentation of a list of denominations, the method comprising a step of choosing a particular denomination in the list of denominations carried out between the step of presenting at least one denomination relating to the reference present or entered manually in the zone of the support and the combination step.

14. The method according to claim 13, during which the step of presenting the list of denominations comprises at least one step of calculating occurrences of these denominations and a display step of these occurrences on the support.

15. The method according to claim 12, during which, in the absence of identification of at least one reference during the implementation of the first search step, the manual selection step of a zone of the support comprises a sub-step of selection of a zone of the support which has not been identified at the end of the first search step and a sub-step of manual entry of a reference in a zone of the drawing which has not been identified at the end of the first search step.

16. The method according to claim 12, during which, in the event of an error in location of at least one reference during the implementation of the first search step, the manual selection step of a zone of the support comprises a sub-step of replacing a reference identified in the drawing at the end of the first search step by a reference entered manually.

17. The method according to claim 12, during which the electronic unit identifies the denomination in relation to the reference entered manually by implementing the second search step, then combines on the support said denomination identified with the reference entered manually.

18. The method according to claim 12, where the support is at least one annotated drawing comprising the referenced drawing and at least one denomination associated with a reference by implementation of the association step and at least one denomination combined with a reference by implementing the modification sequence.

19. The method according to claim 12, where the support comprises at least one glossary comprising at least the denomination identified or entered manually and the reference identified during the first search step or entered manually, the electronic unit associating the glossary with the referenced drawing carrying at least one reference present in the glossary, the electronic unit being configured to display the glossary next to the referenced drawing.

20. The method according to claim 12, in which the document is an industrial property title and the referenced drawing is a drawing of the industrial property title, the electronic unit applying the second search step and/or the modification sequence to at least one claim of the industrial property title.

21. A non-transitory computer-readable storage medium including computer executable instructions, wherein the instructions, when executed by a computer, cause the computer to perform the method according to claim 12.

22. A system for assisting in interpretation of a document comprising at least one referenced drawing and a text associated with the referenced drawing, the system comprising at least:
a first means of searching for at least one reference in the referenced text or on the referenced drawing;
a second means of searching in the text for at least one denomination relating to the reference identified by the first search means;
an association means associating the denomination identified by the second search means with the reference identified by the first search means;
a means of generating a support which illustrates the association made by the association means; and
a modification module which comprises:
at least a first means making it possible to manually select a zone of the support,
at least one second means configured to present at least one denomination in relation to a reference present or entered in zone of the support or configured to manually enter a denomination, and
at least one means of combining the denomination presented or manually entered with the reference present or manually entered in the zone of the support, the system being configured to display said combination on the support.
